(19) United States
(12) Patent Application Publication
(10) Pub. No.: US 2017/0336126 A1
(43) Pub. Date: Nov. 23, 2017

(54) SYSTEMS AND METHODS OF CONTROLLING PRODUCT TEMPERATURES DURING DELIVERY

(71) Applicant: Wal-Mart Stores, Inc., Bentonville, AR (US)

(72) Inventors: David C. Winkle, Bella Vista, AR (US); Donald R. High, Noel, MO (US); Brian G. McHale, Chadderton Oldham (GB); Todd D. Mattingly, Bentonville, AR (US)

(21) Appl. No.: 15/598,718

(22) Filed: May 18, 2017

Related U.S. Application Data
(60) Provisional application No. 62/338,290, filed on May 18, 2016.

(51) Int. Cl. F25D 3/10; B65D 83/26; B60H 1/00; B65D 81/18; B65D 83/14; B65D 83/16

(52) U.S. Cl. CPC F25D 3/105; B60H 1/00264; B65D 81/18; B65D 83/265; B60H 1/0025; B65D 83/16; B65D 83/14; F25D 3/10; F25D 2700/12; F25D 2700/16; B65D 83/26

(57) ABSTRACT

In some embodiments, systems and methods are provided that limit the change in temperature and/or control a temperature of a product during delivery. Some embodiments provide systems to limit temperature changes of a product during transit, comprising: aerosol temperature control system comprising a product holder configured to support a product, wherein the product holder is separate from the delivery vehicle and comprises a temperature sensor, and an aerosol dispenser system that comprises a reservoir configured to hold aerosol material, an actuator and a dispenser; and a temperature control circuit coupled with the temperature sensor and the actuator, wherein the temperature control circuit is configured to receive temperature data, determine based on current temperature data that a temperature of the first product is greater than a first transport temperature threshold, and to autonomously activate the actuator while the first product is in transit.

### CROSS-REFERENCE TO RELATED APPLICATION

This application claims the benefit of U.S. Provisional Application No. 62/338,290, filed May 18, 2016, which is incorporated herein by reference in its entirety.

### TECHNICAL FIELD

This invention relates generally to product temperature control systems.

### BACKGROUND

In a modern retail environment, there is a need to improve the customer service and/or convenience for the customer. One aspect of customer service is the delivery of products. There are numerous ways to delivery products to customers. Getting the product to a delivery location, however, can adversely affect the product, can cause undesirable delays, can add cost and reduce revenue.

### BRIEF DESCRIPTION OF THE DRAWINGS

Disclosed herein are embodiments of systems, apparatuses and methods pertaining to product temperature control systems. This description includes drawings, wherein:

FIG. 1 illustrates a simplified block diagram of an exemplary delivery coordinating system configured to coordinate and/or schedule delivery of products while limiting temperature changes and/or maintaining temperatures of one or more products while transported to one or more delivery locations, in accordance with some embodiments.

FIG. 2 illustrates an exemplary system for use in implementing methods, techniques, devices, apparatuses, systems, servers, sources and the like in limiting temperature changes of a product during transit, in accordance with some embodiments.

FIG. 3 illustrates a simplified cross-sectional view of an exemplary aerosol temperature control system, in accordance with some embodiments.

FIG. 4 illustrates a simplified flow diagram of an exemplary process of limiting temperature changes of a product during transit, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to limit changes in temperature of one or more products being transported to a delivery location. By limiting changes of temperature, products can be kept below or above threshold temperatures, maintain a freshness of products, and other such benefits. In some embodiments, the system identifies various delivery parameters in selecting a product cooling system, from multiple different available cooling systems, that is to be used in limiting temperature changes and/or maintaining temperatures of one or more products while the one or more products are transported to one or more delivery locations. The cooling systems can be implemented to provide temperature control of one or more products, typically a limited number of products, and without having to control the temperature of an entire delivery vehicle or large compartment of a delivery vehicle. Accordingly, the multiple product cooling systems can limit temperature variations and/or control temperatures specific to individual or limited numbers of products. Further, in some embodiments the cooling systems are configured to have a relatively small volume. In some implementations, the product temperature control systems (e.g., product cooling systems) can provide individual temperature control for a single product. Such individual temperature control allows individual products to be transported by some delivery methods while still maintaining desired temperature thresholds, and/or can transport one or more products that are to be maintained at different desired temperatures along with other products that do not require temperature control by the same delivery vehicle.

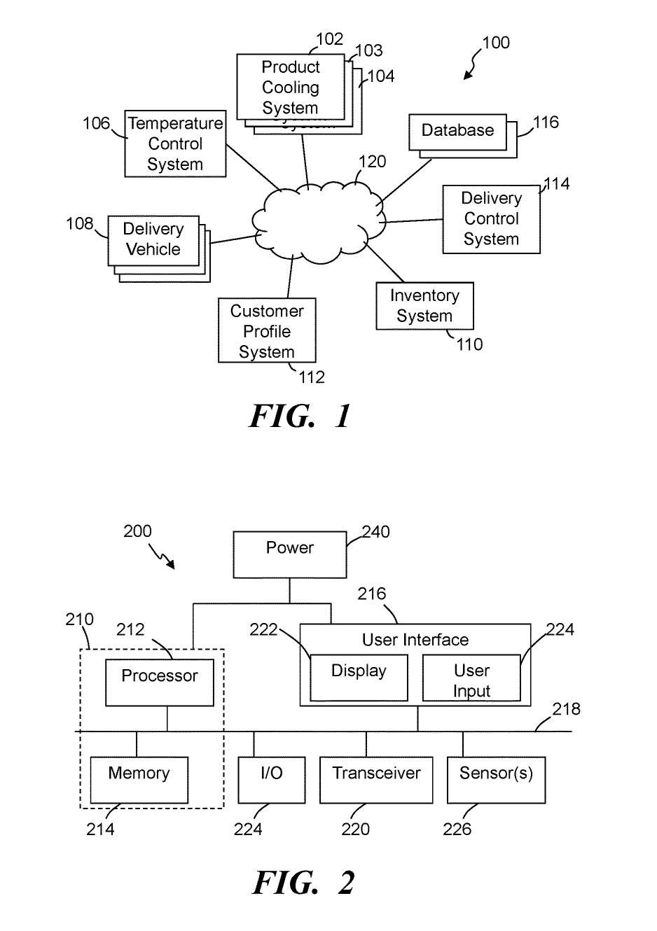

FIG. 1 illustrates a simplified block diagram of an exemplary product delivery coordinating system 100 that is configured to coordinate and/or schedule delivery of products while limiting temperature changes and/or maintaining temperatures of one or more products while transported to one or more delivery locations, in accordance with some embodiments. The system 100 includes multiple different types of product cooling systems 102-104 and/or product heating systems, a temperature control selection system 106, and multiple different types of delivery vehicles 108. Some embodiments further include one or more inventory systems 110 associated with one or more retail facilities, customer profile system 112, delivery control system 114, and one or more databases 116 (e.g., one or more customer databases, inventory databases, product databases, route parameter databases, etc.). One or more computer and/or communication networks 120 establish communication connections between two or more of the components of the system 100 and allow communications and/or data transmissions between two or more of the components of the system 100. In some embodiments, the delivery coordinating system 100 is associated with one or more retail facilities from which products can be purchased and/or that coordinates delivery of those products. The shopping facility may, in some instances, be a retail sales facility, a fulfillment center, a distribution center, or other type of facility in which products are sold and/or distributed to customers. The facility may be any size or format, and may include products from one or more merchants. For example, a facility may be a single store operated by one merchant, a chain of two or more stores operated by one entity, or may be a collection of stores covering multiple merchants.

The temperature control selection system 106 utilizes product parameters and delivery parameters in evaluating which product cooling system and/or delivery vehicle are to be employed in transporting one or more products to one or more delivery locations. Typically, the temperature control selection system identifies products that have one or more temperature thresholds that are to be maintained and/or not to be exceeded. For example, a products may have one or more of a desired storage threshold temperature, a desired transport temperature, a regulatory or government specified temperature threshold, other such temperature thresholds, and in some instances a combination of two or more temperature thresholds. Further, some of the temperature thresholds may correspond to time thresholds, where for a particular product it may be desired that the product be maintained below a first temperature threshold, but can exceed the first temperature for less than a threshold duration of time and typically while being maintained under a second temperature threshold. One or more databases may be accessed (e.g., product database, inventory database, regulatory database, etc.) to obtain information about one or more temperature thresholds and/or corresponding duration thresholds.

Further, the temperature control selection system typically takes into consideration transportation parameters in selecting a product cooling system 102-104 to be used in transporting one or more products. The transport parameters can include, but are not limited to, expected duration of transport and/or duration of exposure to non-temperature controlled environments (e.g., outside of a freezer or refrigerator), predicted and/or forecasted environmental conditions through which the product(s) is to be transported (e.g., temperatures, humidity, potential wind, precipitation, etc.), and other such information. The transportation parameters may be obtained based on historic data (e.g., historic weather, historic traffic patterns, data obtained from similar previous deliveries, etc.) and forecasted data (e.g., forecasted weather, forecasted traffic, etc.), current data, and the like. Further, the transportation parameters may be obtained based on information collected by the retail store or chain of stores, and/or one or more third party sources (e.g., one or more weather services, traffic service, delivery service, etc.). Typically, the transportation parameters can further include and/or consider the time, temperature and the like associated with the preparation and/or loading of the product into a cooling system and/or the delivery vehicle, the unloading of the delivery vehicle, and other such factors. The system may take other parameters into consideration including, but not limited to, product parameters (e.g., type of product, size of product, size of multiple products (e.g., sum of volumes and/or volume of strategically arranged products), and the like), customer requests, types of delivery location, whether a temperature control system is available at the delivery location, whether a customer is expected to be available to receive the product(s) at the time of delivery, and other such parameters, and often a combination of two or more of such parameters.

Further, the processes, methods, techniques, circuits, circuitry, systems, devices, functionality, services, servers, sources and the like described herein may be utilized, implemented and/or run on many different types of devices and/or systems. FIG. 2 illustrates an exemplary system 200 that may be used for implementing any of the components, circuits, circuitry, systems, functionality, apparatuses, process, or device of the system 100 of FIG. 1 and/or mentioned above or below, or parts of such circuit, circuitry, functionality, systems, apparatuses, processes, or devices. For example, the system 200 may be used to implement some or all of the product cooling systems 102-104, a temperature control selection system 106, delivery vehicles 108, inventory systems 110, customer profile system 112, delivery control system 114, and/or other such components, circuitry, functionality and/or devices. However, the use of the system 200 or any portion thereof is certainly not required.

By way of example, the system 200 may comprise a control circuit or processor module 212, memory 214, and one or more communication links, paths, buses or the like 218. Some embodiments may include one or more user interfaces 216, and/or one or more internal and/or external power sources or supplies 240. The control circuit 212 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 212 can be part of control circuitry and/or a control system 210, which may be implemented through one or more processors with access to one or more memory 214 that can store code that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 200 may be used to implement one or more of the above or below, or parts of, components, circuits, systems, process and the like. For example, the system may implement the temperature control selection system 106 with the control circuit being a selection system control circuit, product cooling system with the control circuit being a cooling system control circuit, a product delivery control system with the control circuit being a product delivery control circuit, a temperature control system with a temperature control circuit, or other components.

The user interface 216 can allow a user to interact with the system 200 and receive information through the system. In some instances, the user interface 216 includes a display 222 and/or one or more user inputs 224, such as a buttons, touch screen, track ball, keyboard, mouse, etc., which can be part of or wired or wirelessly coupled with the system 200. Typically, the system 200 further includes one or more communication interfaces, ports, transceivers 220 and the like allowing the system 200 to communicate over a communication bus, a distributed computer and/or communication network 120 (e.g., a local area network (LAN), the Internet, wide area network (WAN), etc.), communication link 218, other networks or communication channels with other devices and/or other such communications or combinations thereof. Further the transceiver 220 can be configured for wired, wireless, optical, fiber optical cable, satellite, or other such communication configurations or combinations of two or more of such communications. Some embodiments include one or more input/output (I/O) ports 234 that allow one or more devices to couple with the system 200. The I/O ports can be substantially any relevant port or combinations of ports, such as but not limited to USB, Ethernet, or other such ports.

The system 200 comprises an example of a control and/or processor-based system with the control circuit 212. Again, the control circuit 212 can be implemented through one or more processors, controllers, central processing units, logic, software and the like. Further, in some implementations the control circuit 212 may provide multiprocessor functionality.

The memory 214, which can be accessed by the control circuit 212, typically includes one or more processor readable and/or computer readable media accessed by at least the control circuit 212, and can include volatile and/or nonvolatile media, such as RAM, ROM, EEPROM, flash memory and/or other memory technology. Further, the memory 214 is shown as internal to the control system 210; however, the memory 214 can be internal, external or a combination of internal and external memory. Similarly, some or all of the memory 214 can be internal, external or a combination of internal and external memory of the control circuit 212. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory. The memory 214 can store code, software, executables, scripts, data, content, lists, programming, programs, log or history data, user information and the like. While FIG. 2 illustrates the various components being coupled together via a bus, it is understood that the various components may actually be coupled to the control circuit and/or one or more other components directly.

Some embodiments include the I/O interface 234 that allows wired and/or wireless communication coupling of to external components, such as with one or more product cooling systems 102-104, temperature control selection system 106, delivery vehicles 108, inventory systems 110, customer profile system 112, delivery control system 114, databases 116, and other such devices or systems. Typically, the I/O interface provides wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some implementations, the system 200 includes one or more sensors 226 that can communicate sensor data to the control circuit 212 and/or other systems. The sensors can include one or more temperature sensors, humidity sensors, inertial sensors, wind speed sensors, acceleration sensors, velocity sensors, weight sensor systems, dimensions sensor systems, product identifying sensor systems (e.g., RFID tag readers, bar code scanners, cameras and text capture systems, etc.), other such sensors, or combination of two or more of such sensors. The sensors may communicate wired or wirelessly over the communication link 218, the distributed computer and/or communication network 120, or the like. Further, the sensors 226 are illustrated directly coupled with the control circuit 212 via the communication link 218; however, one or more sensors may be internal, external or a combination of internal and external, other networks or communication channels with other devices and/or other such communications or combinations thereof. For example, in some applications one or more temperature sensors may be positioned within a product holder or cavity of a cooling system, adjacent to or as part of a product holder, incorporated into insulation, external to a housing of a cooling system, other such locations, or combination of two or more of such locations. Additionally or alternatively, one or more sensors and/or sensor systems may be cooperated with and/or positioned as part of or adjacent to a conveyor system that transports products in preparation for delivery, as part of a transport system (e.g., forklift, pallet jack, etc.), and/or other such systems.

As described above, some embodiments include the temperature control selection system 106 that evaluates multiple parameters to select one or more product temperature control systems, from multiple different types of temperature control systems, to be used while delivering one or more products. The temperature control systems can comprise one or more aerosol temperature control systems with aerosol control system control circuit, evaporative temperature control systems with evaporative control system control circuit, cryogenic substance cooling systems with cryogenic cooling system control circuit, temperature pack cooling systems, cooling sustaining bag systems, heat pack temperature systems, other temperature control systems, or combination of two or more of such systems. In some embodiments, the temperature control selection system 106 further takes into consideration expected rates of change in temperature and/or expected heat transfer of the one or more products, applied cryogenic substance, insulation, insulation rating or thermal resistance rating, and the like. In some embodiments, the rate of change of temperature is calculated based on a formula for each flow (e.g., ΔQ/Δt=−K×A×ΔT/x, where ΔQ/Δt is the rate of heat flow; −K is the thermal conductivity factor; A is the surface area; ΔT is the change in temperature and x is the thickness of the material).

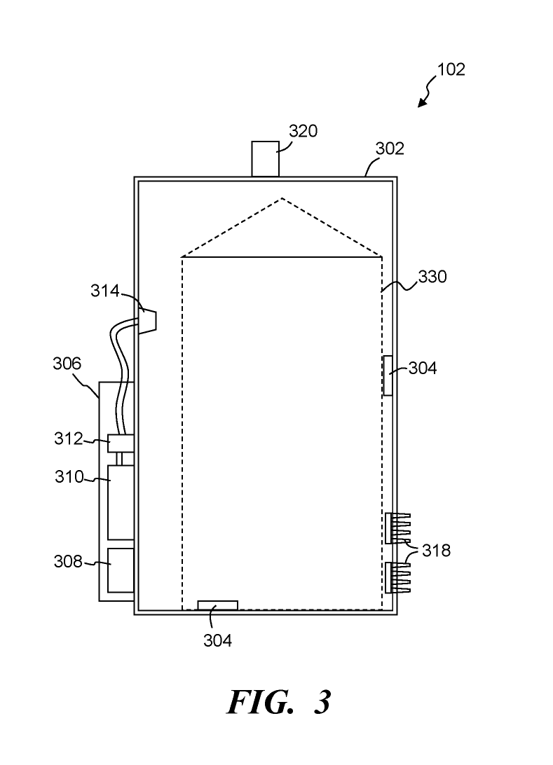

FIG. 3 illustrates a simplified cross-sectional view of an exemplary aerosol temperature control system 102, in accordance with some embodiments. The temperature control system 102 includes at least one product holder 302, one or more temperature sensors 304, and one or more aerosol dispenser systems 306. In some embodiments, the aerosol temperature control system 102 includes or is in communication with a temperature control circuit or system 308.

The product holder 302 is configured to support and/or receive one or more products 330 while the one or more products are transported by a delivery vehicle to a delivery location. At least the product holder 302 is separate from and removable from the delivery vehicle 108, and in some instances the aerosol temperature control system is separate from and removable from the delivery vehicle. In other instances, however, some the aerosol temperature control system may be secured with the delivery vehicle (e.g., the aerosol dispenser system 306 may be secured with the delivery vehicle, and/or some or all of the temperature control circuit 308 may be implemented through a control circuit of the delivery vehicle).

The size of the aerosol temperature control system 102 can vary, but often is configured to hold a relatively small number of products, such as products that collectively have a volume of less than three cubic feet, typically less than two cubic feet, and often less than one cubit foot. Depending on the size of the product, often the cooling system is capable of only receiving a single product. In some embodiments, the cooling system has dimensions that are marginally larger than the one or more products being received by the cooling system. Further, the aerosol temperature control systems may have multiple different sizes, with a particular aerosol temperature control system being selected based on the size or volume of one or more products intended to be placed into the product holder. For example, in some applications, the temperature control system adds less than 15% to a total volume of the one or more products (and their packaging) being received, while in some instances is sized such that it adds 10% or less to a volume of the one or more products being received by the temperature control system.

In some embodiments, the product holder holds the one or more products with at least some of the product packaging exposed to the exterior environment while being transported by the delivery vehicle. For example, one the product holder may include a frame with one or more straps, claps, grippers, spring loaded arms, other such mechanisms or combination of such mechanisms to support and hold the one or more products. In other embodiments, the one or more products can be enclosed within the product holder 302. In some instances the product holder includes an interior wall forming an interior product compartment or cavity, and an exterior wall. One or more insulators may be positioned between the walls. In some implementations, the interior and/or exterior walls are rigid, while in other implementations one or both of the interior and exterior walls may be flexible. For example, the interior and exterior walls may, in some embodiments, be formed from a plastic, wax coated paper, or other materials. The interior wall is typically moisture resistant and/or water proof. In a bag configuration, portions of the interior and/or exterior wall may be rolled and/or folded over to close the product compartment. In some embodiments, the product holder further includes a mounting or coupling system 320 that is configured to secure the product holder with a delivery vehicle. In some instances, the coupling system includes an aperture and/or gripper to cooperate with a hook (e.g., to be suspended by an unmanned aerial system (UAS)), or other such system that secures the product holder with the delivery vehicle. Other embodiments may include latches that secure with a delivery vehicle, grooves that receive tongs or other structure of a delivery vehicle, or other such structures that can be used to releasably cooperate the product holder with the delivery vehicle.

One or more temperature sensors 304 is positioned to detect in real time a temperature corresponding to a temperature of the one or more products supported by the product holder while are in transit to be delivered to a delivery location. In some instances, a temperature sensor may be positioned in contact with a product. Additionally or alternatively, one or more temperature sensors may be positioned at one or more locations proximate the product and/or within the product compartment. Some embodiments include one or more temperature sensors that can detect temperatures outside of the cooling system. In some embodiments, one or more other types of sensors may be included, such as but not limited to one or more humidity sensors, inertia sensors, orientation sensors (e.g., tilt, roll, pitch, yaw, etc.), airflow sensors, other such sensors, or combination of two or more of such sensors. The sensors are in wired or wireless communication with the temperature control circuit 308 and provide sensor data to the temperature control circuit.

At least a portion of the aerosol dispenser system 306 is positioned relative to at least one product supported by the product holder. In some embodiments, the aerosol dispenser system comprises one or more reservoirs 310, one or more actuators 312, and one or more dispensers 314. The one or more reservoirs 310 are configured to hold one or more aerosol materials that are to be dispensed to limit temperature change and/or adjust a temperature of one or more products. The actuator 312 is cooperated with one or more of the reservoirs and in some implementations releasably seals the reservoir. Upon activation, the actuator releases at least a portion of the aerosol material, which is typically under pressure within the reservoir. Each of the one or more dispensers 314 are cooperated with at least one of the reservoirs 310, such as through one or more conduits, and positioned to dispense the aerosol material. The one or more dispensers are configured to generate a spray, mist, cloud, stream, or other such release of the aerosol material. In some instances, the dispenser is adjustable to select from multiple different dispensing modes or methods (e.g., adjust between stream, spray, and mist, or some combination thereof). Further, dispensing controller may cooperate with the dispenser allowing the temperature control circuit to automatically adjust one or more of the dispensers to a desired dispensing method. Additionally or alternatively, one or more dispensers may be manually adjustable and a worker can set the dispenser to a desired dispensing method.

The one or more dispensers are positioned to dispense the aerosol material in order to limit temperature changes and/or reduce a temperature of the one or more products. In many applications, one or more dispensers are positioned to direct the aerosol material directly at one or more of the products to contact a packaging of the product, the product, and/or a wrap that has been placed about at least a portion of the product. Additionally or alternatively, one or more dispensers may be positioned to release the aerosol material to contact one or more heat sinks 318 that can be in contact with one or more products (e.g., part of the packaging or in contact with packaging of the product) and/or extending from the product compartment. Additionally or alternatively, one or more dispensers may be positioned to inject a fog or cloud of the aerosol material into the product compartment. A type of dispenser utilized and/or the type of release of the aerosol material from the dispenser may depend in part on the aerosol material being dispersed. The aerosol material utilized may depend on the product being transported and/or the one or more temperature thresholds corresponding to the product being transported. The aerosol material can be substantially any relevant aerosol material that can provide a desired temperature change and/or maintain a desired temperature. For example, the aerosol material may be a water, salt-water, carbon dioxide, nitrogen, ammonia, alcohol, material(s) that causes an endothermic reaction, material(s) that causes an exothermic reaction, other such material, or combination of two or more of such materials. Further, the aerosol material may be in a compressed format (e.g., compressed carbon dioxide), an uncompressed state, a liquid state, a gaseous state, or other such formats or states.

The temperature control circuit 308 receives real time temperature data from the one or more temperature sensors 304 while the product is in transit to the delivery location. In some embodiments, the temperature control circuit couples with one or more of the temperature sensor and the actuator 312. Based on current temperature data the temperature control circuit can determine or identify when a temperature of the product is greater than one or more transport temperature thresholds. The transport temperature threshold may be specific to a particular product and typically varies between products. Further, the transport temperature threshold may be limited to while the product is in transit, while one or more other temperature thresholds may be relevant to the product while the product is at a retail facility or other storage location. For example, for some products that are kept cold a transport temperature threshold may be greater than a storage temperature threshold (e.g., ice cream may have a transport temperature threshold that allows a slow melting of the ice cream, while the storage temperature threshold maintains the ice cream in a frozen state). Further, some transport temperature thresholds may further be associated with a time threshold. For example, some products may have multiple transport temperature thresholds with a first transport temperature threshold being less than a second transport temperature threshold, such that the product can exceed the first temperature threshold for a threshold period of time while remaining below the second temperature threshold.

In some embodiments, the temperature control circuit autonomously activates aerosol dispenser system 306 and/or one or more actuators 312 to release one or more aerosol materials while the product is in transit. The actuator may be a valve, plunger, puncture pin, compressed gas, other such actuators or combination of two or more of such devices. The activation releases the aerosol that is dispensed through one or more dispensers 314. In some instances, multiple dispensers are distributed around the product, product holder, product compartment, and/or into a cavity between the interior and exterior walls to allow more control of where the aerosol is released, provide a more equal distribution of the aerosol material, increase an amount of aerosol that is released at a given activation, and the like. The release of the aerosol material is configured to maintain and/or cause a reduction in temperature of the one or more products. Some embodiments position one or more of the dispensers 314 proximate a packaging of one or more products such that the one or more dispensers direct at least a majority of the dispersed aerosol material directly at the packaging of the one or more products.

Further, the aerosol material may be stored in the reservoir in a compressed form, an uncompressed form, a liquid form, a gaseous form, other such forms, or combination of such forms (e.g., liquid or gas, and compressed). Some embodiments include two or more reservoirs 310, and at least two of those reservoirs can include different types of aerosol materials. Some embodiments include a primary reservoir that can store a first or primary aerosol material that upon release is at a first temperature and/or has a first evaporation rate. A secondary reservoir can store a secondary aerosol material that upon release is at a second temperature and/or has a second evaporation rate that is different than the first evaporation rate. For example, the secondary aerosol material can have the second evaporation rate that is greater than the first evaporation rate such that the secondary aerosol material evaporates more rapidly than the first aerosol material when both are in the same conditions. The multiple different aerosol materials can provide the temperature control circuit with greater control over maintaining the temperature of the product and/or a rate of temperature change. In some instances, for example, the temperature control circuit can identify that a current temperature corresponding to a product and/or the temperature of the product is greater than a rapid cool transport temperature threshold, which may be different that a transport temperature threshold. When the temperature control circuit detects that temperature being greater than the rapid cool transport temperature threshold the temperature control circuit can activate the aerosol dispenser system (or a secondary aerosol dispenser system associated with the secondary reservoir) to release the secondary aerosol material onto the product, heat sink, wrap, into the product compartment, into an evaporative cavity, or the like, or a combination thereof. With the greater evaporation rate, the secondary aerosol material is expected to provide a more rapid temperature reduction of the product. Similarly, the two or more different aerosol material can cooperatively be used to achieve a desired temperature and/or maintain a temperature within multiple different thresholds do to the variations in concentrations of the two or more aerosol material used.

Some embodiments may use a wrap or distributing materials that can be wrapped about at least a portion of the product, positioned within the product compartment, and/or positioned between the interior and exterior walls. One or more dispensers 314 can be positioned to direct the aerosol material onto the wrap or distributing material. The wrap and distributing material can be substantially any material that can at least partially absorb and/or wick the aerosol material and allows evaporation from the aerosol material. In some applications the wrap or distributing material is a fibrous material that provides a relatively large surface area and/or allows airflow through the fibrous material. The wrap or distributing material may further provide some insulation between the product or product compartment and the exterior environment.

As described above, the temperature control selection system 106 can select a type of temperature control and/or cooling system from multiple different types of temperature control and/or cooling systems. For example, the temperature control selection system may consider the aerosol temperature control system 102, an evaporative product cooling system, a temperature pack product cooling system, a cryogenic product cooling system, aerosol product cooling system, a cooled sustaining container product cooling system, other such temperature control systems, or systems that include two or more temperature control systems, such as two or more of the above described product cooling systems. In some embodiments, the temperature control selection system considers a type or method of transport and delivery. For example, the method of transport may be through one or more methods such as, but not limited to, a delivery truck, a delivery van, a delivery car, an unmanned ground or land-based vehicle (UGV), an unmanned aircraft system (UAS), other such delivery methods, or combination of such delivery methods. Other cooling systems are described in U.S. Application Nos. 62/338,246 filed May 18, 2016 and entitled TEMPERATURE PACK COOLING SYSTEMS AND METHODS OF CONTROLLING PRODUCT TEMPERATURES DURING DELIVERY (137872); 62/338,231 filed May 18, 2016 entitled CRYOGENIC COOLING SYSTEMS AND METHODS OF CONTROLLING PRODUCT TEMPERATURES DURING DELIVERY (137873); 62/338,224 filed May 18, 2016 entitled EVAPORATIVE COOLING SYSTEMS AND METHODS OF CONTROLLING PRODUCT TEMPERATURES DURING DELIVERY (137875); 62/345,443 filed Jun. 3, 2016 entitled TEMPERATURE CONTROL SYSTEMS USING TEMPERATURE SUSTAINING BAGS AND METHODS OF CONTROLLING PRODUCT TEMPERATURES DURING DELIVERY (138251); 62/403,909 filed Oct. 4, 2016 entitled SYSTEMS AND METHODS UTILIZING NANOTECHNOLOGY INSULATION MATERIALS IN LIMITING TEMPERATURE CHANGES DURING PRODUCT DELIVERY (137874); 62/350,515 filed Jun. 16, 2016 entitled SYSTEMS AND METHODS OF CONTROLLING PRODUCT TEMPERATURES DURING DELIVERY (138259); 62/367,376 filed Jul. 27, 2016 entitled SYSTEMS AND METHODS FOR DELIVERING PERISHABLE ITEMS (138262); and ______, filed May 18, 2017 entitled EVAPORATIVE COOLING SYSTEMS AND METHODS OF CONTROLLING PRODUCT TEMPERATURES DURING DELIVERY (Attorney Docket No. 8842_137875-US 1441US02); all of which are incorporated herein by reference in their entirety.

Some temperature control systems may not be suitable for some of the delivery methods, some temperature control systems may be more effective with some methods of delivery, and/or some temperature control systems may be more readily implemented with some delivery methods. Accordingly, the temperature control selection system may identify a scheduled method of delivering and/or transporting the one or more products, and select the aerosol temperature control system as a method of temperature control based in part of the method of delivery and/or transport. For example, when a method of delivery is through the use of a UAS or UGV, the cooling system may be exposed to the environment as the product is transported by the UAS or UGV. As such, the aerosol temperature control system may be particularly beneficial with such delivery methods because the aerosol material may be exposed to the environment as the UAS or UGV transports the product, and in some instances evaporation is enhanced because of the exposure to the wind that is at least induced while the UAS or UGV is moving. Further, the weight of temperature control systems used particularly with UASs, and in some instances with UGVs, can make some cooling systems difficult to use. In many instances, the aerosol temperature control system 102 can be implemented to have a relatively light weight (e.g., product holder can be made from plastic, metal, cotton, nylon, fiberglass, other such materials or combination of two or more of such materials), and the reservoir can in at least some applications be relatively small (e.g., less than two pound and often less than half a pound). For example, the reservoir may comprise a small compressed gas cartridge that is reusable or disposable. Accordingly, the aerosol temperature control system can be a desired method of cooling with some delivery methods. Such delivery parameters corresponding to the method of delivery can be considered by the temperature control selection system, which can select the aerosol temperature control system for some methods of transport and delivery. Further, in some implementations, the temperature control selection system may select two or more of the temperature control systems to be cooperatively utilized during the delivery, and/or one to be used as a primary cooling system with one or more to be utilized as secondary cooling method and/or backup cooling method. Further, multiple methods of delivery may be used (e.g., delivery truck and a UAS). Accordingly, multiple temperature control systems may be selected. The temperature control selection system, in some applications, is configured to obtain a temperature threshold of a product, identify a method of transport of the product by the delivery vehicle to the delivery location, and select from multiple different types of temperature control systems the aerosol temperature control system as a function of the method of transport. This selection may be based on the product(s), the delivery vehicle, product temperature threshold, exterior conditions and the like. For example, when the delivery vehicle is a UAS, the system may be selected with an aerodynamically enhanced shape and a reduced weight.

In some embodiments, the aerosol temperature control system is configured for use in relatively short duration transports and/or to be implemented to induce a quick change in temperature of one or more products. For example, the aerosol temperature control system may be limited to transport times that correspond to approximately the flight time of a UAS to a delivery location, and typically with a margin of error, such as +50% of the flight time. As further examples, the aerosol temperature control system may be limited to transport times (which can include time to stage the product and cooling system, load the delivery vehicle, transport the product, and deliver the product to the customer, and in some instances may include time after delivery before a customer is expected to retrieve the delivery) of less than four hours, and in some instances restricted to transport times of less than two hours.

Again, in some embodiments the delivery vehicle can be an unmanned aircraft system (UAS). The UAS is configured to secure and lift the product holder 302 and the one or more products supported by the product holder while the UAS transports the aerosol temperature control system and the product by air to the delivery location. The aerosol temperature control system limits a temperature change of the product.

The temperature control circuit, in some applications, can further be configured to control an orientation of the product holder and/or the product relative to a direction of travel of the delivery vehicle. In some embodiments, the temperature control circuit is determines a desired orientation of the product and/or the product holder relative to a direction of travel. The desired orientation may be based on a desired position of one or more dispensers, positioning one or more surfaces of a product and/or product packaging relative to airflow causes at least in part by the movement of the delivery vehicle, modifying airflow relative to applied aerosol material, and/or other such factors. For example, in some applications the temperature control circuit can identify, in response to determining that the temperature of a product being carried by the product holder is greater than a transport temperature threshold, an orientation of one or more dispensers relative to a direction of travel of the product and/or delivery vehicle while in transit to be delivered to the delivery location. The temperature control circuit can further determine a desired orientation of the one or more dispensers relative to the direction of travel to achieve a desired dispersion of the aerosol material.

Based on the desired orientation, the temperature control circuit can cause one or more instructions to be communicated to cause a modification of the orientation of the product holder as the delivery vehicle travels toward the delivery location to modify an orientation of the one or more products relative to the direction of travel while the delivery vehicle is in route (e.g., while the UAS is in flight). In some applications, the temperature control circuit autonomously communicates one or more instructions to the delivery vehicle to cause the change in orientation of the product holder and/or the product. For example, when the delivery vehicle is a UAS, the instruction can be communicated to the UAS to cause the UAS to rotate a specified number of degrees relative to a direction of travel. Similarly, when the delivery vehicle is a UGV, the instruction can cause the UGV to change directions for a period of time and/or activate a mechanism on the UGV to rotate the product cooling system 102. As another example, the instructions can cause the UAS can rotate a product holder coupler to cause the product holder to rotate relative to the UAS.

In some implementations, the temperature control circuit identifies, in response to determining that the temperature of a product is greater than a transport temperature threshold, an orientation of one or more dispensers 314 relative to a direction of travel of the product and/or the product holder while in transit to be delivered to the delivery location. A desired orientation of the dispenser relative to the direction of travel can further be determined. The desired orientation may, in some instances, correspond to achieving a desired dispersion of the aerosol material. The temperature control circuit can autonomously communicate instructions and/or cause instructions to be communicated to cause a modification of an orientation of dispenser relative to the direction of travel. Instructions can further be communicated to activate one or more actuators 312 while the one or more dispensers are in the desired orientation. Some embodiments further control the quantity of aerosol material that is released through a dispenser. The amount of aerosol material may, is some instances, be determined based on historic data corresponding to changes in temperature and/or rates of change of temperature of products relative to quantities of aerosol material applied.

Some embodiments further take into consideration the airflow relative to the product, the orientation of the one or more dispensers, the effect on evaporation, and/or other effects. As described above, in some embodiments, the product holder includes a product compartment into which one or more products are positioned. The compartment can include a series or array of holes exposing the compartment to an exterior environment and/or expose a cavity between the walls of the compartment to the exterior environment. In some embodiments, the temperature control circuit can determine a desired orientation of the product holder relative to the direction of travel to achieve a desired airflow across, into and/or through the series of holes, and in some instances into the compartment. Additional instructions can be communicated to cause a modification of the orientation of the product holder as the delivery vehicle travels toward the delivery location to modify the airflow across and/or through the series of holes to achieve a desired airflow across and/or through one or more holes. This orientation of the series of holes may be a different orientation than a desired orientation of a dispenser when releasing the aerosol material. For example, the instructions to orient the product holder to achieve a desired orientation of the series of holes may occur after the product holder is oriented to position the dispenser in a desired orientation.

Further, in some implementations, the temperature control circuit can determine a desired velocity of the delivery vehicle as a function of the received temperature data and/or airflow data to control airflow into the compartment, a rate of evaporation of the aerosol material, and the like. Similar to the evaluation of orientation, the temperature control circuit can evaluate historic data relative to causing changes in temperature, evaporation rates, etc., relative to one or more parameters such as but not limited to type of aerosol material, environmental temperature, desired temperature within the product compartment and/or of the product, temperature or estimated temperature of the product relative to one or more temperature thresholds, other such parameters, and often two or more of such parameters. When a change in velocity is desired, the temperature control circuit can autonomously communicate an instruction to the delivery vehicle to cause a modification in velocity of the delivery vehicle to be consistent with the desired velocity. This control in velocity may be made in cooperation with or alternative to a change in orientation of the aerosol temperature control system relative to a direction of travel. In some applications, the temperature control circuit may communicate (e.g., via wireless communication, such as cellular, Wi-Fi, etc.) with a central control system that may evaluate some or all of the data, such as temperature data, airflow data and/or other such data to determine adjustments that the temperature control circuit is to implement. Typically, however, the temperature control circuit can operate autonomously without communicating with the central control system in determining when and/or whether to make adjustments to release aerosol material, increase a rate of release of aerosol material, cause an adjustment of an orientation of the delivery vehicle, cause an adjustment of an orientation of the aerosol temperature control system 102, cause an adjustment of a speed of the delivery vehicle, activate a secondary aerosol dispenser system, activate a secondary cooling system (e.g., evaporative cooling system, cryogenic cooling system, etc.), and/or other such actions.

In some embodiments, the temperature control circuit considers the change in temperature caused by contact of the aerosol material and/or evaporation rate of the aerosol material, which can be determined based on historic data corresponding to changes in temperature, changes in evaporation rate and/or temperatures as a function of changes in airflow across and/or through the series of holes. The temperature control circuit further has knowledge of the positioning and/or configuration of the series of holes (e.g., the series of holes may only be on a limited number of sides and/or across a limited area of the product holder, and can cause an adjustment in orientation to cause an adjustment in airflow relative to one or more holes. In some embodiments, the aerosol temperature control system 102 may include one or more airflow sensors that can provide airflow data to the temperature control circuit. The temperature control circuit can utilize this airflow data in cooperation with a current orientation, positioning and/or mapping of the series of holes to achieve a desired temperature relative to the product.

In some embodiments, the product holder includes one or more heat sinks 318, and in some instances a series of heat sinks that are configured to be in contact with the product while positioned within the compartment. One or more dispensers can be positioned to direct at least a portion of the aerosol material onto the series of heat sinks. Similarly, the orientation of the product holder can be adjusted to achieve a desired orientation of the series of heat sinks.

Further, in some implementations, the temperature control circuit can determine a desired velocity of the delivery vehicle as a function of the received temperature data and/or airflow data to control when to activate the aerosol dispenser system, quantities of aerosol material to release, a rate of evaporation, and the like. Similar with the evaluation of orientation, the temperature control circuit can evaluate historic data relative to dispensing the aerosol material, causing changes in evaporation rates, and/or changes in temperature with products relative to one or more parameters such as but not limited to differences in velocity, type of aerosol material, environmental temperature, desired product temperature, temperature or estimated temperature of the product relative to one or more temperature thresholds, other such parameters, and often two or more of such parameters. When a change in velocity is desired, the temperature control circuit can autonomously communicate an instruction to the delivery vehicle to cause a modification in velocity of the delivery vehicle to be consistent with the desired velocity. This control in velocity may be made in cooperation with or alternative to a change in orientation of the aerosol temperature control system 102 relative to a direction of travel. In some applications, the temperature control circuit may communicate (e.g., via wireless communication, such as cellular, Wi-Fi, etc.) with a central control system that may evaluate some or all of the data, such as temperature data, airflow data and/or other such data to determine adjustments that the temperature control circuit is to implement. Typically, however, the temperature control circuit can operate autonomously without communicating with the central control system in determining when and/or whether to make adjustments to release aerosol material, adjust an orientation of the delivery vehicle, adjust an orientation of the aerosol temperature control system 102, adjust a speed of the delivery vehicle, activate a secondary aerosol dispenser system, activate a secondary cooling system, and/or other such actions.

Some embodiments additionally or alternatively take advantage of ambient conditions to implement evaporative cooling and/or enhance the evaporative cooling. In some instances, a UAS delivery vehicle 108 may fly through a cloud that deposits moisture on at least the exterior surface of the product holder 302 and/or the product 330 within the product holder depending on the construction of the product holder (e.g., a mesh, multiple holes, etc.). This exterior moisture evaporates to enhance the cooling and/or limit a change in temperature within the product holder 302. The continued flight of the UAS delivery vehicle can be controlled to further adjust a rate of evaporation of the moisture that adheres to the exterior walls. For example, the temperature control circuit 308 can receive temperature sensor data and detect a change in temperature of the exterior wall and/or a change in the rate of change of temperature within the product cavity of the product holder to identify an evaporative effect on the exterior wall. Additionally or alternatively, one or more moisture sensors may be positioned to detect exterior moisture. The rate of evaporation of the exterior moisture in part can be controlled based on a speed of the UAS delivery vehicle, an orientation of the product holder 302 while being transported, rate of release of the aerosol material on the product, a wall of the product holder, and the like.

Further, in some embodiments, the temperature control circuit 308 may receive an indication of exterior moisture and cause a change in orientation of the product holder while the exterior moisture is present to enhance a distribution of the exterior moisture across a larger area of one or more exterior walls and/or all of the exterior walls. Similarly, one or more evaporative openings may be adjusted to reduce evaporation from within the product holder as a result of the exterior moisture and expected enhanced exterior evaporation. In some implementations, the UAS delivery vehicle may be routed with attempts to interact with clouds, fog or other conditions to take advantage of exterior moisture and evaporative effects, which can save aerosol material, battery power, and the like. For example, it may be identified through one or more remote sensors and/or weather data that clouds are present at a determined altitude, and the UAS delivery vehicle can be directed by the temperature control circuit and/or a central system to fly at an altitude that is expected to allow the product cooling system to interact with the exterior moisture. The temperature control circuit 320 and/or a central system can evaluate current conditions relative to historic conditions in identifying when it is expected that sufficient external moisture sources are to be available along a delivery route. Further, in some implementations the delivery route may be modified to allow the product cooling system to interact with expected exterior moisture sources.

Although FIG. 3 shows an aerosol temperature control system with a single product holder and product compartment, other embodiments may include multiple different product holders and/or product compartments. Further, some embodiments utilize a single aerosol dispenser system, while other embodiments may employ multiple different aerosol dispenser systems. Still further, an aerosol dispenser system may cooperated with a single product holder or product compartment, or cooperate with multiple product holders or product compartments.

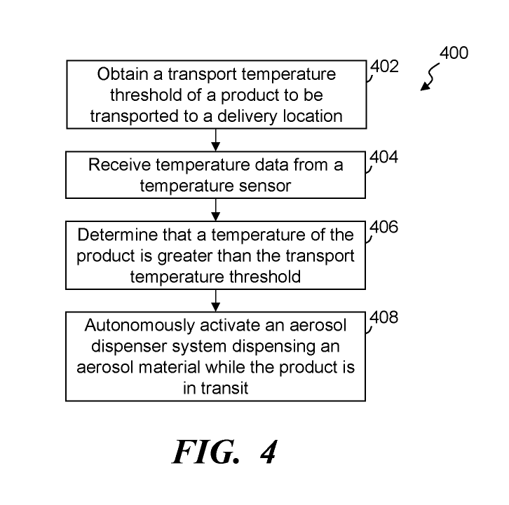

FIG. 4 illustrates a simplified flow diagram of an exemplary process 400 of limiting temperature changes of a product during transit, in accordance with some embodiments. In step 402, a transport temperature threshold is obtained for a product to be transported to a delivery location by a delivery vehicle. One or more temperature thresholds (and in some instances corresponding duration thresholds) may be associated with a product. The temperature threshold may be a minimum temperature, a maximum temperature, a desired transport temperature, a temperature associated with a corresponding duration of time, or the like.

In step 404, temperature data is received while the product is being transported to the delivery location by the delivery vehicle. In some embodiments, the temperature data is received from one or more temperature sensors 304 of a product holder of an aerosol temperature control system 102. The product holder is typically separate from and removable from the delivery vehicle and supports one or more products while the one or more products are transported to the delivery location. In some implementations, the aerosol temperature control system and/or a size of an aerosol temperature control system is selected based on a volume, shape and/or dimensions of the product to be carried. For example, the selected aerosol temperature control system may have dimensions that are similar to the product being delivered and adds less than 20% to the volume of space occupied by the product, and in some instances adds less than 10%.

In step 406, it is determined based on current temperature data that a temperature of the product is greater than a transport temperature threshold associated with the product. In step 408, an actuator of a selected aerosol dispenser system, which may secured adjacent to and/or with the product holder and positioned relative to the product, is autonomously activated. For example, a temperature control circuit 308 may autonomously evaluate temperature data and activate the actuator 312 without input from an external system or device. An aerosol material is dispensed from one or more dispensers 314 of the aerosol dispenser system 306, in response to the activation of the actuator and while the one or more products are in transit, to reduce a temperature of one or more products.

Some embodiments cause the delivery vehicle, which may be an unmanned aircraft system (UAS), an unmanned ground vehicle (UGV), delivery truck, delivery van, or the like, to carry the product holder and the one or more products supported by the product holder and transport the product holder and the one or more product to the delivery location. For example, in some embodiments the aerosol temperature control system is utilized with an unmanned aircraft system (UAS), and can cause the UAS to lift the product holder and one or more products supported by the product holder, and transport the product holder and the one or more products by air to the delivery location.

In some implementations, a desired orientation of the product can be determined, while the product is in transit, relative to a direction of travel. One or more instructions can be communicated to cause a modification of the orientation of the product holder and a modification of the orientation of the product relative to the direction of travel while the delivery vehicle transports the product (e.g., while a UAS is in flight). The communication may be directed to the delivery vehicle, or an orientation system of the product holder or delivery vehicle which can alter the orientation of the product and/or product holder while in transit. In some instances, the temperature control circuit 308 can communicate directly to the delivery vehicle. In other instances, the temperature control circuit may communicate to a central control system that can cause one or more instructions to be communicated to the delivery vehicle to cause a change in orientation of the product holder relative to the delivery vehicle and/or a direction of travel.

In activating an actuator 312 of the aerosol dispenser system 306, some embodiments direct at least a majority of the dispersed aerosol material directly at a packaging of the product being transported by the delivery vehicle. With one or more dispensers positioned to be aimed at the product packaging, the actuator can release the aerosol material toward the one or more dispensers that direct the aerosol material at the product packaging.

Some embodiments identify, in response to determining that a temperature of a product being carried by the product holder is greater than a transport temperature threshold, an orientation of one or more dispensers relative to a direction of travel while in transit to the delivery location. A desired orientation of one or more dispensers can be determined relative to the direction of travel to achieve a desired dispersion of the aerosol material. For example, in some instances, the desired orientation of at least one of the dispensers is opposite the direction of travel so that the aerosol material when dispersed is directed opposite the direction of travel and in the same direction as wind induced because of the movement of the delivery vehicle. The wind can aid in carrying the aerosol material and/or by being directed in parallel with the wind the wind is less likely to disperse the aerosol material before the aerosol material contacts the product packaging, heat sink, or other surface that the aerosol is intended to contact. One or more instructions can be communicated to cause a modification of an orientation of dispenser relative to the direction of travel. This instruction cause the delivery vehicle to change its orientation relative to the direction of travel and thus the orientation of the product holder and dispenser, cause a rotation of the product holder, or some other modification of orientation of the one or more dispensers. Once in the desired orientation, the actuator can be activated while the dispenser is in the desired orientation.

Additionally or alternatively, some embodiments control an orientation of the product holder in part to control an airflow across, into and/or around one or more holes. In some embodiments, a desired orientation of the product holder relative to the direction of travel is determined to achieve a desired airflow into, across and/or through a series of holes and into a compartment in which the a product is positioned. One or more instructions can be communicated to cause a modification of the orientation of the product holder as the delivery vehicle travels toward the delivery location to modify the airflow through the series of holes. Again, the change in orientation can be implemented by a change in orientation of the delivery vehicle (e.g., causing a UAV to rotate a selected number of degrees relative to a direction of travel and/or based on a direction of wind), a rotation of the product holder, or other such modification of an orientation of the product holder relative to the direction of travel.

In some embodiments, actuator is activated to cause the dispenser to direct at least a portion of the aerosol material onto one or more heat sinks that are in contact with one or more product while positioned within the compartment of the product holder, and/or that are cooperated with an enclosed compartment of the product holder. Further, some embodiments select aerosol temperature control system at least in part based on method of transport. A method of transport of the product by the delivery vehicle to the delivery location can be identified. The temperature control selection system 106 can select from multiple different types of temperature control systems an aerosol temperature control system 102 that includes the product holder 302 and aerosol dispenser system 306 as a function of the method of transport.

Additionally, in some embodiments, multiple different types and/or configurations of the aerosol temperature control system 102 may be available. Typically, multiple different sizes of aerosol temperature control system are available and a particular one can be selected based in part on the number of products being transported and the size or volume of the one or more products. For example, some embodiments may provide multiple different sized aerosol temperature control systems, and the sized aerosol temperature control system may be selected to be the smallest available system that can receive the one or more products and be used to transport the one or more products. In some embodiments, the temperature control selection system 106 and/or other system can obtain an optimum stacking and/or positioning of the multiple products within the one or more product compartments, and instructions can be provided to a worker (e.g., written, illustrations, etc. that can be communicated to a personal device (e.g., smartphone, tablet, etc.), displayed through a computer, communicated as an email or text, or otherwise provided to the worker) to direct the worker in positioning the one or more products with the product holder of the selected aerosol temperature control system. Similarly, the system may select one or more aerosol materials to be used and provide instructions that direct the worker to cooperate one or more types of aerosol materials with the selected aerosol temperature control system (e.g., attach an aerosol reservoir 310 with the aerosol dispenser system 306). These different aerosol materials can be used independently and/or collectively.

In some embodiments, systems, apparatuses, methods, and process are provided to limit temperature change of one or more products during delivery. Some embodiments comprise: an aerosol temperature control system comprising a product holder configured to support a first product while the first product is transported to a delivery location by a delivery vehicle, wherein the product holder is separate from and removable from the delivery vehicle and further comprises a temperature sensor cooperated with the product holder and positioned to detect in real time a temperature corresponding to a temperature of a first product while the first product is in transit to be delivered to the delivery location, and an aerosol dispenser system positioned relative to the first product, wherein the aerosol dispenser system comprises a reservoir configured to hold aerosol material, an actuator cooperated with and releasably sealing the reservoir, and a dispenser cooperated with the reservoir and positioned to dispense the aerosol material; and a temperature control circuit coupled with the temperature sensor and the actuator, wherein the temperature control circuit is configured to receive temperature data from the temperature sensor while the first product is in transit to the delivery location, determine based on current temperature data that a temperature of the first product is greater than a first transport temperature threshold, and to autonomously activate the actuator while the first product is in transit.

Further, some embodiments provide methods of limiting temperature changes of a product during transit, comprising: obtaining a first transport temperature threshold of a first product to be transported to a delivery location by a delivery vehicle; receiving, while the first product is being transported to the delivery location by the delivery vehicle, temperature data from a temperature sensor of a product holder that is separate from and removable from the delivery vehicle and that supports the first product while the first product is transported to the delivery location; determining based on current temperature data that a temperature of the first product is greater than the first transport temperature threshold; and autonomously activating an actuator of an aerosol dispenser system secured with the product holder and positioned relative to the first product, wherein the activating the actuator comprises dispensing an aerosol material from the aerosol dispenser system while the first product is in transit to reduce a temperature of the first product.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system to limit temperature changes of a product during transit, comprising:
an aerosol temperature control system comprising a product holder configured to support a first product while the first product is transported to a delivery location by a delivery vehicle, wherein the product holder is separate from and removable from the delivery vehicle and further comprises a temperature sensor cooperated with the product holder and positioned to detect in real time a temperature corresponding to a temperature of a first product while the first product is in transit to be delivered to the delivery location, and an aerosol dispenser system positioned relative to the first product, wherein the aerosol dispenser system comprises a reservoir configured to hold aerosol material, an actuator cooperated with and releasably sealing the reservoir, and a dispenser cooperated with the reservoir and positioned to dispense the aerosol material; and
a temperature control circuit coupled with the temperature sensor and the actuator, wherein the temperature control circuit is configured to receive temperature data from the temperature sensor while the first product is in transit to the delivery location, determine based on current temperature data that a temperature of the first product is greater than a first transport temperature threshold, and to autonomously activate the actuator while the first product is in transit.

2. The system of claim 1, wherein the delivery vehicle comprises an unmanned aircraft system (UAS) configured to secure and lift the product holder and the first product supported by the product holder while the UAS transports the first product by air to the delivery location.

3. The system of claim 2, wherein the temperature control circuit is further configured to determine a desired orientation of the first product relative to a direction of travel, and to communicate an instruction to cause a modification of the orientation of the product holder as the delivery vehicle travels toward the delivery location to modify an orientation of the first product relative to the direction of travel while the UAS is in flight.

4. The system of claim 1, wherein the dispenser is positioned proximate a packaging of the first product and directs at least a majority of the dispersed aerosol material directly at the packaging of the first product.

5. The system of claim 1, wherein the temperature control circuit is configured to identify, in response to determining that the temperature of the first product is greater than the first transport temperature threshold, an orientation of the dispenser relative to a direction of travel while in transit to the delivery location, to determine a desired orientation of the dispenser relative to the direction of travel to achieve a desired dispersion of the aerosol material, to communicate an instruction to cause a modification of an orientation of dispenser relative to the direction of travel, and to activate the actuator while the dispenser is in the desired orientation.

6. The system of claim 5, wherein the product holder comprises a compartment into which the first product is positioned, wherein the compartment comprises a series of holes exposing the compartment to an exterior environment;
wherein the temperature control circuit is further configured to determine a desired orientation of the product holder relative to the direction of travel to achieve a desired airflow through the series of holes and into the compartment, and to communicate an additional instruction to cause a modification of the orientation of the product holder as the delivery vehicle travels toward the delivery location to modify the airflow through the series of holes.

7. The system of claim 6, wherein the product holder comprises a series of heat sinks that are configured to be in contact with the first product while positioned within the compartment, wherein the dispenser is positioned to direct at least a portion of the aerosol material onto the series of heat sinks.

8. The system of claim 1, further comprising:
a temperature control selection system configured to obtain a temperature threshold of the first product, identify a method of transport of the first product by the delivery vehicle to the delivery location, and select from multiple different types of temperature control systems an aerosol temperature control system comprising the product holder and the temperature control circuit as a function of the method of transport.

9. A method of limiting temperature changes of a product during transit, comprising:
obtaining a first transport temperature threshold of a first product to be transported to a delivery location by a delivery vehicle;
receiving, while the first product is being transported to the delivery location by the delivery vehicle, temperature data from a temperature sensor of a product holder that is separate from and removable from the delivery vehicle and that supports the first product while the first product is transported to the delivery location;
determining based on current temperature data that a temperature of the first product is greater than the first transport temperature threshold; and
autonomously activating an actuator of an aerosol dispenser system secured with the product holder and positioned relative to the first product, wherein the activating the actuator comprises dispensing an aerosol material from the aerosol dispenser system while the first product is in transit to reduce a temperature of the first product.

10. The method of claim 9, further comprising:
causing the delivery vehicle, comprising an unmanned aircraft system (UAS), to lift the product holder and the first product supported by the product holder and transport the product holder and the first product by air to the delivery location.

11. The method of claim 10, further comprising:
determining, while the first product is in transit, a desired orientation of the first product relative to a direction of travel; and
communicating an instruction to cause a modification of the orientation of the product holder and modification of the orientation of the first product relative to the direction of travel while the UAS is in flight.

12. The method of claim 11, wherein the activating the actuator comprises directing at least a majority of the dispersed aerosol material directly at a packaging of the first product.

13. The method of claim 9, further comprising:
identifying, in response to determining that the temperature of the first product is greater than the first transport temperature threshold, an orientation of the dispenser relative to a direction of travel while in transit to the delivery location;
determining a desired orientation of the dispenser relative to the direction of travel to achieve a desired dispersion of the aerosol material; and
communicating an instruction to cause a modification of an orientation of dispenser relative to the direction of travel;
wherein the activating the actuator comprises activating the actuator while the dispenser is in the desired orientation.

14. The method of claim 13, further comprising:
determining a desired orientation of the product holder relative to the direction of travel to achieve a desired airflow through a series of holes and into a compartment in which the first product is positioned; and
communicating an additional instruction to cause a modification of the orientation of the product holder as the delivery vehicle travels toward the delivery location to modify the airflow through the series of holes.

15. The method of claim 14, wherein the activating the actuator to cause the dispenser to direct at least a portion of the aerosol material onto a series of heat sinks that are in contact with the first product while positioned within the compartment.

16. The method of claim 9, further comprising:
identifying a method of transport of the first product by the delivery vehicle to the delivery location; and
selecting from multiple different types of temperature control systems an aerosol temperature control system comprising the product holder and aerosol dispenser system as a function of the method of transport.
